(19) United States
(12) Patent Application Publication
(10) Pub. No.: US 2011/0278425 A1
(43) Pub. Date: Nov. 17, 2011

(54) VIBRATION ISOLATION SYSTEM WITH A UNIQUE LOW VIBRATION FREQUENCY

(76) Inventor: Sung-Tae Park, Geumjeong-gu Busan (KR)

(21) Appl. No.: 13/120,135

(22) PCT Filed: Sep. 17, 2009
(86) PCT No.: PCT/KR2009/005297

§ 371 Date: May 27, 2011

(30) Foreign Application Priority Data
Sep. 19, 2008 (KR) 10-2008-0092313

(51) Int. Cl. F16F 15/04

(52) U.S. Cl. 248/636

(57) ABSTRACT

A vibration isolation system is provided. The vibration isolation system includes a negative stiffness device which is additionally installed in the vibration isolation system which includes a main spring which is connected between a first object (mass) and a second object (a support) to isolate vibrations transmitted between the first and second objects due to a relative motion between the first and second objects. The negative stiffness device is disposed parallel with a main spring installed between the first and second objects to be installed in a direction which forms a right angle with directions of the relative motions of the first and second objects. Therefore, the negative stiffness device maintains stiffness of the main spring and lowers a change rate of potential energy of the vibration isolation system with respect to a displacement of the vibration isolation system, thereby increasing a vibration isolation effect. Since the negative stiffness device includes a linear auxiliary spring and a link, a structure of the negative stiffness device is simplified to be easily installed in the vibration isolation system and to be manufactured at very low cost. A natural frequency of the vibration isolation system is maintained at a lowest value (between 0 Hz and 1 Hz) to effectively isolate shocks or vibrations transmitted to the first and second objects. Therefore, the vibration isolation system provides a stable and comfortable feeling to a driver or a passenger of a vehicle or maintains a detailed precision degree of a machine system.

### TECHNICAL FIELD

The present invention relates generally to a vibration isolation system with a low natural frequency, and more particularly, to a vibration isolation system which includes an auxiliary device having a negative stiffness effect to lower a change rate of whole potential energy of the vibration isolation system caused by a displacement of a mass (a first object) or a support (a second object) in order to reduce a natural frequency of the vibration isolation system to a lowest value (theoretically to 0 Hz), substantially to below 1 Hz, i.e., to be close to 0 Hz, thereby increasing a vibration isolation effect.

### BACKGROUND ART

In general, vibrations, which are transmitted to a driver and a passenger from the road through a body of a vehicle, such as a bus, a truck, a heavy vehicle, and various types of conveying machines, badly affect physical aspects, such as backache, headache, shoulder ache, and eyesight failing, work efficiency, and a performance of the vehicle. In order to solve this problem, a vibration isolation system, such as a suspension, is applied to the above-mentioned various types of vehicles or devices to absorb and inhibit shocks or vibrations, which may occur during travelling on the uneven road, in order to minimize the shocks or vibrations.

Precision machinery uses a vibration isolation system between a machine and a support, which supports the machine, to minimize effects of vibrations occurring from the machine. In particular, if a precision machine or a precision measuring machine and a system require a detailed precision degree, a high-priced, complicated active type isolation device or a pneumatic isolation device is generally used to isolate vibrations produced from a support point between the machine and the support.

A model of a conventional vibration isolation system 300 is shown in FIG. 1. Referring to FIG. 1, the conventional vibration isolation system 300 includes a first object 310, a second object 320, and a main spring 330. Alternatively, the conventional vibration isolation 300 may further include a damper 340.

The first and second objects 310 and 320 refer to parts of objects which receive vibrations and shocks. The main spring 330 buffers the one of the first and second objects 310 and 320 against the vibrations and the shocks transmitted from the other one of the first and second objects 310 and 320, thereby producing a vibration isolation effect. A method of adjusting a damping value of a damper has been widely used in the conventional vibration isolation system 300. However, applying a technique for lowering a natural frequency of the vibration isolation system 300 may be a more effective method.

In order to realize this method, a spring constant k (stiffness) is required to be set low in a natural frequency

$${ω}_{n} = \sqrt{\frac{k}{m}} .$$

However, as the spring constant k is lowered, a static displacement of the vibration isolation system increases. Therefore, a position maintenance or a normal operation required in the vibration isolation system is impossible, and thus the spring constant k is not lowered to a predetermined threshold value. In other words, as stiffness of the spring becomes lowered, the natural frequency becomes lowered, thereby increasing a vibration isolation effect. However, static displacement of an object increases, and thus a position of a passenger or a machine is not maintained.

Accordingly, since a stiffness value of a spring is designed to satisfy an opposite effect between a vibration isolation effect and a static position, the natural frequency is not lowered to a predetermined threshold value.

Here, the model of the vibration isolation system 300 of FIG. 1 may be applied to vehicles, including the bus, the truck, the heavy vehicle, a motorcycle, and the various types of conveying machines, precision machines, precision measuring devices, etc., to be applied to a driver's seat of a vehicle. Therefore, the vibration isolation system 300 may isolate vibrations transmitted to a driver of the vehicle. The vibration isolation system 300 will now be exemplarily described in more detail.

FIG. 2 is a perspective view illustrating a conventional vibration isolation system of a driver's seat in which a vertical type main spring is installed. FIG. 3 is a perspective view illustrating a conventional vibration isolation system of a driver's seat in which a horizontal type main spring is installed.

Referring to FIGS. 2 and 3, the conventional vibration isolation system includes a lower rail guide 11, an upper rail guide 12, a support link 13, and a main spring 14. The lower rail guide 11 is fixedly installed in a vehicle body, and the upper rail guide 12 is located above the lower rail guide 11 and has an upper surface to which a seat cushion is connected. The support link 13 has an X shape and is connected between the lower and upper rail guides 11 and 12 to move the upper rail guide 112 with up and down motions of the lower rail guide 11. The main spring 14 is connected between the lower and upper rail guides 11 and 12 or to a side of the support link 13 to buffer vibrations transmitted from the vehicle body.

The main spring 14 is generally classified into a vertical type main spring used as a compression spring and a horizontal type main spring used as a tension spring, according to types of used springs.

As shown in FIG. 2, an end of the main spring 14 which is the vertical type is fixed onto an upper surface of the lower rail guide 11, and an other end of the main spring 14 is supportably installed on a fixed plate 10 formed on an upper surface of the upper rail guide 12. Therefore, the main spring 14 relieves vibrations or shocks transmitted to the vibration isolation system.

As shown in FIG. 3, both ends of the main spring 14 which is the horizontal type are respectively fixedly installed onto left and right link rotation rollers 13a and 13b of the support link 13. Thus, the main spring 14 relieves vibrations or shocks transmitted to a suspension system of the vehicle.

As described above, the conventional vibration isolation system used for the vehicle includes the support link 13 having the X shape and the main spring 14, which are installed between the upper and lower rail guides 12 and 11, to buffer produced vibrations. However, since a compression or tension degree of the main spring 14 changes according to a driver's weight, i.e., a load applied to a seat, a structure of the conventional vibration isolation system has limitation with respect to a decrease in the natural frequency.

In other words, in order to lower a natural frequency, spring stiffness of a main spring is to be lowered. This increases static displacement of the vibration isolation system and thus disables the vibration isolation system to perform its original function. Therefore, it is impossible to lower stiffness of the main spring to be less than or equal to a predetermined threshold value.

Also, since the conventional vibration isolation system including the main spring generally has a natural frequency between 1.5 Hz and 3 Hz, the conventional vibration isolation system has high vibration transmissivity in a low frequency band between 4 Hz and 10 Hz in which a driver feels most greatly tired due to vibrations.

Accordingly, in order to reduce vibration energy transmitted to a driver from a vehicle body in a low frequency band between 4 Hz and 10 Hz in which the driver feels most greatly tired due to vibrations, a natural frequency of a suspension system is to be maintained to be less than or equal to 1 Hz.

### DISCLOSURE

### Technical Problem

The present invention has been made to address at least the above problems and/or disadvantages and to provide at least the advantages described below. Accordingly, an aspect of the present invention provides a vibration isolation system which includes an auxiliary device to maintain a change rate of potential energy with respect to a displacement of the vibration isolation system to a lowest value in order to have a very low natural frequency, i.e., theoretically a natural frequency of 0 Hz, substantially a natural frequency less than or equal to 1 Hz and close to 0 Hz, thereby effectively isolating shocks or vibrations transmitted to an object.

### Technical Solution

According to one aspect of the present invention, a negative stiffness device is provided that is additionally installed in a vibration isolation system having a main spring which is connected between first and second objects to isolate vibrations transmitted between the first and second objects due to a relative motion between the first and second objects. The negative stiffness device includes an auxiliary spring which is initially installed in a maximum tension or compression state to relieve an initial maximum tension displacement or an initial maximum compression displacement according to the relative motion between the first and second objects.

The negative stiffness device further includes: a link part which is located between the first and second objects and includes an end which is fixedly installed on a side of the first object to move with up and down movements of the first object; and a support part which is located between the first and second objects and includes an end which is fixedly installed on a side of the second object, wherein the auxiliary spring comprises an end connected to an other end of the link part and an other end connected to an other end of the support part.

Potential energy of the main spring increases more than in a neutral position according to an amount of a compression or tension displacement of the main spring, and potential energy of the auxiliary spring decreases at all times more than in the neutral position according to the amount of the compression or tension displacement, so that an exchange rate of potential energy of the vibration isolation system per time with respect to kinetic energy of the vibration isolation system decreases to lower a natural frequency of the vibration isolation system to be less than or equal to 1 Hz.

The auxiliary spring is installed in a direction which forms a right angle with directions of relative motions of the first and second objects.

The link part includes: a first link which is fixed onto a side of the first object to move up and down with a movement of the first object; a second link which converts the up and down movements of the first link to a horizontal displacement of the auxiliary spring; and a third link which is connected to the second link to enable horizontal back and forth displacements of the auxiliary spring and performs back and forth motions which are guided by a part of the support part.

According to another aspect of the present invention, a vibration isolation system is provided. The vibration isolation system includes: a main spring which is connected between first and second objects and isolates vibrations transmitted due to a relative motion between the first and second objects; and the negative stiffness device.

According to another aspect of the present invention, a vibration isolation suspension system is provided that is used for a seat of a driver of a vehicle. The vibration isolation suspension system includes: an upper rail guide which is fixedly installed on a first object; a lower rail guide which is located under the upper rail guide and is fixedly installed on a second object; a support link which is connected between the upper and lower rail guides to move the upper rail guide up and down based on the lower rail guide; a main spring which is connected between the upper and lower rail guides or is connected to a side of the support link to buffer vibrations transmitted from the first and second objects; and a negative stiffness device which includes: a support plate which is fixedly installed on the second object or an upper part of the lower rail guide; a link housing which is fixedly installed on a side of the support plate and includes a guide part; a link part which includes a third link which is inserted into the guide part to slide inside the guide part in order to horizontally move back and forth, a first link which is fixed onto a side of the upper rail guide to move up and down with a movement of the upper rail guide, and a second link which connects the first and first links to each other to horizontally move the third link back and forth with up and down movements of the first link; and an auxiliary spring which includes an end connected to a side of the link part and an other end connected to a side of the support plate.

The auxiliary spring is initially installed in a maximum tension or compression state to relieve an initial maximum tension or compression displacement due to relative motions of the upper and lower rail guides.

Potential energy of the main spring increases more than in a neutral position according to an amount of a compression or tension displacement of the main spring, and potential energy of the auxiliary spring decreases at all times more than in the neutral position according to the amount of the compression or tension displacement, so that an exchange rate of potential energy of the vibration isolation system per time with respect to kinetic energy of the vibration isolation system decreases to lower a natural frequency of the vibration isolation system to be less than or equal to 1 Hz.

The auxiliary spring is installed in a direction which forms a right angle with directions of relative motions of the first and second objects.

According to another aspect of the present invention, a vibration isolation system is provided. The vibration isolation system includes: a first elastic member which buffers vibrations transmitted between first and second objects, which perform relative motions in a first direction, the first elastic member having minimum potential energy at a neutral position; a second elastic member having potential energy which changes according to the relative motions of the first and second objects; and a link part which connects the first object and the second elastic member to each other so that the potential energy of the second elastic member is maximized in the neutral position.

As relative positions of the first and second objects deviate from the neutral position, the potential energy of the first elastic member increases.

As the relative positions of the first and second objects deviate from the neutral position, the potential energy of the second elastic member decreases.

Whole potential energy of the first and second elastic members is minimized at the neutral position.

As relative positions of the first and second objects deviate from the neutral position, whole potential energy of the first and second elastic members increases.

The first elastic member includes a compression spring.

The first elastic member includes a tension spring.

The second elastic member includes a compression spring which is maximally compressed at the neutral position.

The compression spring is displaced in a second direction different from the first direction. The second direction is perpendicular to the first direction.

The compression spring is displaced while pivoting one end of the compression spring which is pivotably fixed.

The second elastic member includes a tension spring which is maximally tensed at the neutral position.

The tension spring is displaced in a second direction different from the first direction. The second direction is perpendicular to the first direction.

The tension spring is displaced while pivoting on one end of the tension spring which is pivotably fixed.

The link part includes: a first link which is fixed to the first object to move in the first direction; a second link which is connected to the first link to convert a movement direction of the first link to the second direction; and a third link which includes one end connected to the second link and the other end connected to one end of the second elastic member, wherein an other end of the second elastic member is fixed.

The second elastic member includes a tension spring which is displaced in the second direction, wherein the tension spring is maximally tensed in the neutral position.

The second elastic member includes a compression spring which is displaced in the second direction, wherein the compression spring is maximally compressed at the neutral position.

The link part includes a first link which is fixed to the first object to move in the first direction, and the second elastic member includes a compression spring, wherein one end of the compression spring is connected to the first link, and the other end of the compression spring is pivotably fixed.

The compression spring is maximally compressed at the neutral position, and pivots and is displaced on the fixed other end thereof with maintaining a compression state according to the relative motions of the first and second objects.

The link part includes a first link which is fixed to the first object to move in the first direction and includes a curved part, wherein one end of the second elastic member contacts the curved part of the first link, and the other end of the second elastic member is fixed.

The second elastic member contacts the curved part through a roller.

The second elastic member includes a compression spring which contacts the curved part with maintaining a compression state according to the relative motions of the first and second objects.

The curved part is formed so that the compression spring is maximally compressed at the neutral position.

The second elastic member includes a tension spring which contacts the curved part with maintaining a tension state according to the relative motions of the first and second objects.

The curved part is formed so that the tension spring is maximally tensed at the neutral position.

The link part includes: a first link which is pivotably connected to the first object; and a second link which is connected to the first link and includes one end which is pivotably fixed to pivot according to the relative motions of the first and second objects, wherein one end of the second elastic member is connected to the other end of the second link, and the other end of the second elastic member is pivotably fixed.

The second elastic member includes a tension spring, wherein the one end of the second link is disposed in a position in which the tension spring is maximally tensed at the neutral position.

The second elastic member includes a compression spring, wherein the one end of the second link is disposed in a position in which the compression spring is maximally compressed at the neutral position.

The vibration isolation system further includes a damper which attenuates vibrations transmitted between the first and second objects.

The vibration isolation system further includes a support part which fixes an end of the second elastic member.

### Advantageous Effects

A vibration isolation system using a negative stiffness device according to the present invention shows the following effects in comparison with an existing vibration isolation system including only a main spring.

A natural frequency of the vibration isolation system is lowered theoretically to 0 Hz and to be substantially less than or equal to 1 Hz, i.e., to be close to 0 Hz, thereby effectively isolating shocks or vibrations transmitted to the vibration isolation system due to a relative motion between first and second objects. Therefore, the vibration isolation system provides a stable and comfortable feeling to a passenger or maintains detailed precision of a machine system.

Since a structure of the negative stiffness device applied to the vibration isolation system is simple and small, the vibration isolation system is easily manufactured, and a whole weight of the vibration isolation system does hardly increase. Also, the vibration isolation system has high durability and is easily maintained and repaired.

The negative stiffness device has a simple structure, is manufactured at low cost, and is simply attached to the vibration isolation system or is installed in the vibration isolation system through a simple design change.

### DESCRIPTION OF DRAWINGS

The above and other aspects, features and advantages of the present invention will be more apparent from the following detailed description when taken in conjunction with the accompanying drawings, in which:

FIG. 1 is a schematic view illustrating an operation principle of a conventional vibration isolation system;

FIGS. 2 and 3 are perspective views illustrating vibration isolation systems used for a vehicle to which the operation principle of the conventional vibration isolation system of FIG. 1 is applied;

FIG. 4 is a schematic view illustrating an operation principle of a vibration isolation system having a low natural frequency according to an embodiment of the present invention;

FIG. 5 is a graph illustrating a change rate of potential energy of the vibration isolation system of FIG. 4 having the low natural frequency;

FIGS. 6 through 13 are perspective views illustrating negative stiffness devices of the vibration isolation system of FIG. 4 having the low natural frequency, according to various embodiments of the present invention;

FIGS. 14 through 18 are perspective views illustrating a structure and an operation principle of the vibration isolation system of FIG. 4 which is applied to a suspension used for a driver's seat and a main suspension of a vehicle, according to embodiments of the present invention;

FIGS. 19 and 20 are respectively a perspective view and a front view illustrating a structure of the vibration isolation system of FIG. 4 which is installed on a side of an axle of a Mcperson type suspension;

FIGS. 21 and 22 are respectively a perspective view and a front view illustrating a structure of the vibration isolation system of FIG. 4 which is installed on a side of an axle of a Wish-bone type suspension;

FIGS. 23 and 24 are respectively a perspective view and a front view illustrating a structure and an operation principle of a vibration isolation system used for a machinery installation table to which the operation principle of the vibration isolation system of FIG. 4 is applied;

FIG. 25 is a schematic view illustrating an operation principle of a suspension system in which a vertical type compression main spring of FIGS. 15 and 16 is installed;

FIG. 26 is a schematic view illustrating an operation principle of a suspension system in which a horizontal tension type main spring of FIGS. 17 and 18 is installed; and

FIGS. 27 through 38 are schematic views illustrating various structures of a vibration isolation system of the present invention depending on the change of shapes of a main spring, an auxiliary spring, a link part and the change of an installation position of the link part.

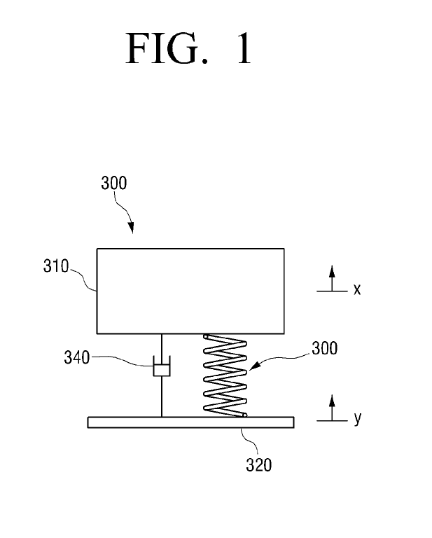

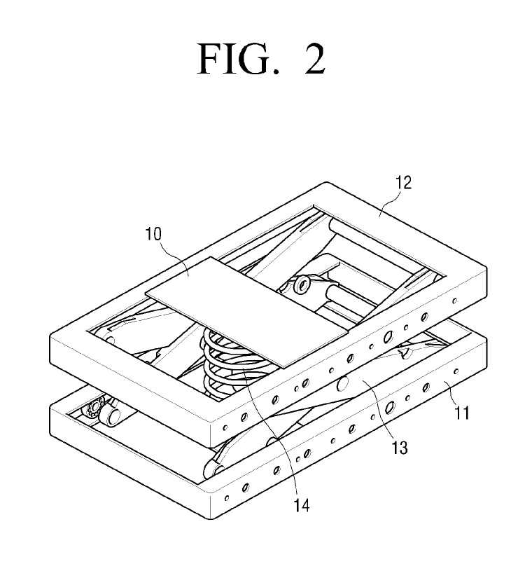

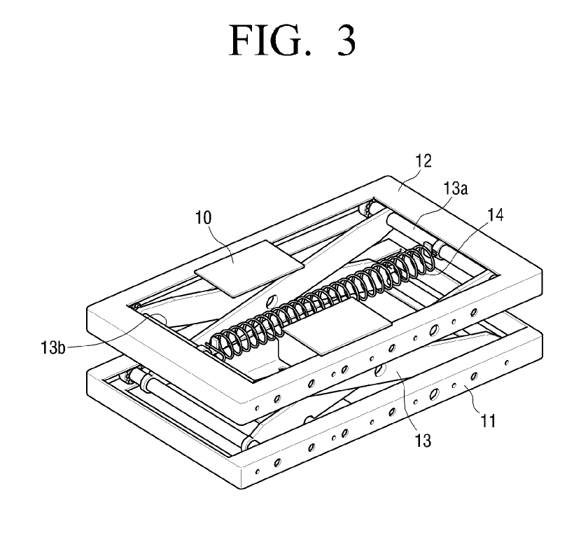

### BEST MODE

Embodiments of the present invention are described in detail with reference to the accompanying drawings. The terms or words used in the present specification and claims are not construed as being limited to general or dictionary meanings. The terms should be construed as meanings and concepts agreeing with the spirit of the present invention based on that the inventor can appropriately define concepts of the terms to explain the present invention as the best way.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention.

A structure and an operation principle of a vibration isolation system according to an exemplary embodiment of the present invention will now be described.

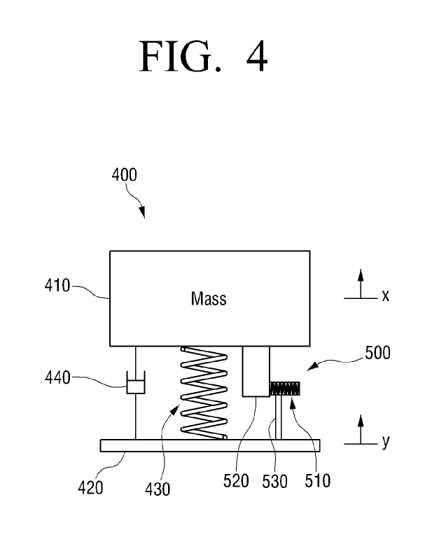

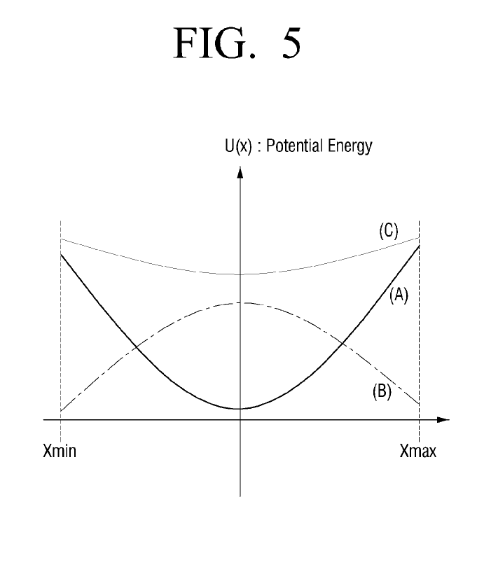

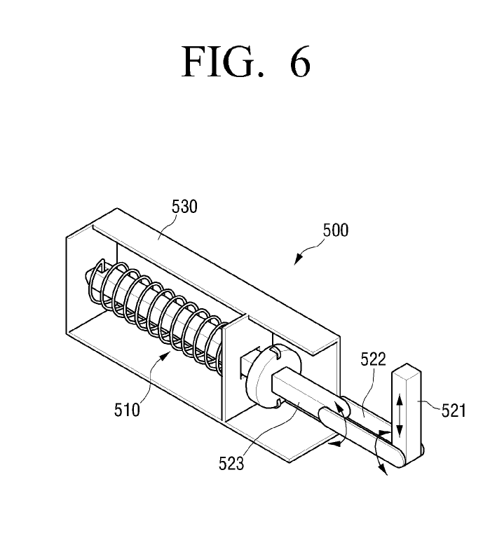

FIG. 4 is a schematic view illustrating an operation principle of a vibration isolation system having a low natural frequency according to an embodiment of the present invention. FIG. 5 is a graph illustrating a change rate of potential energy of the vibration isolation system of FIG. 4 having the low natural frequency. FIGS. 6 through 13 are perspective views illustrating negative stiffness devices of the vibration isolation system of FIG. 4 having the low natural frequency, according to various embodiments of the present invention.

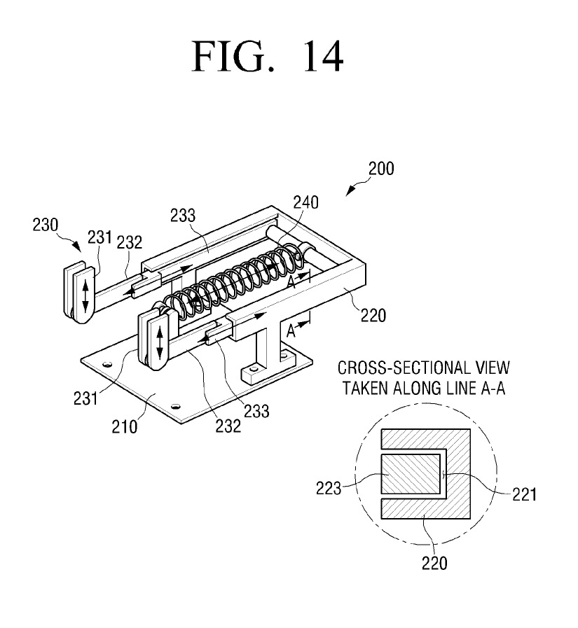

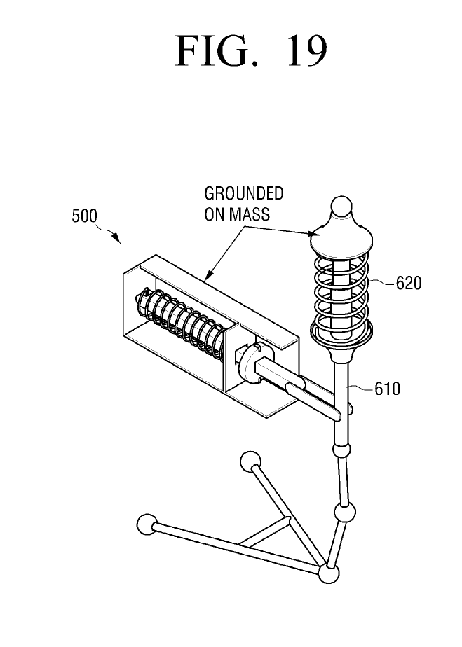

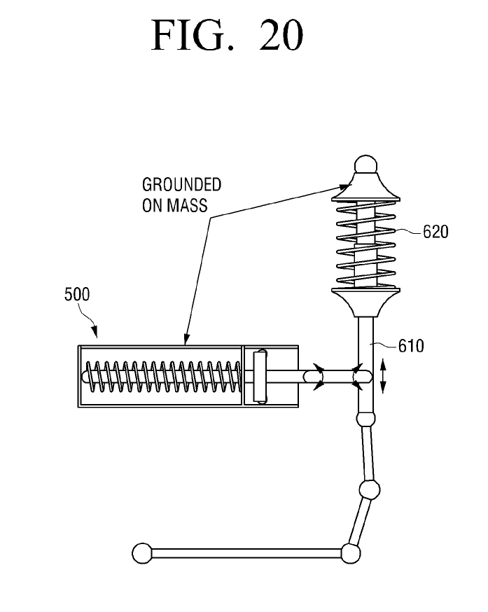

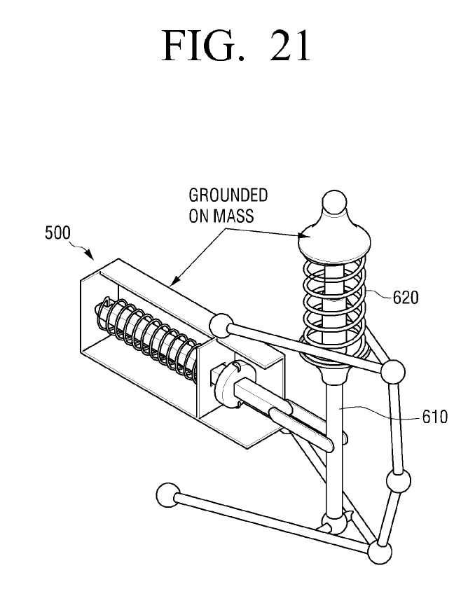

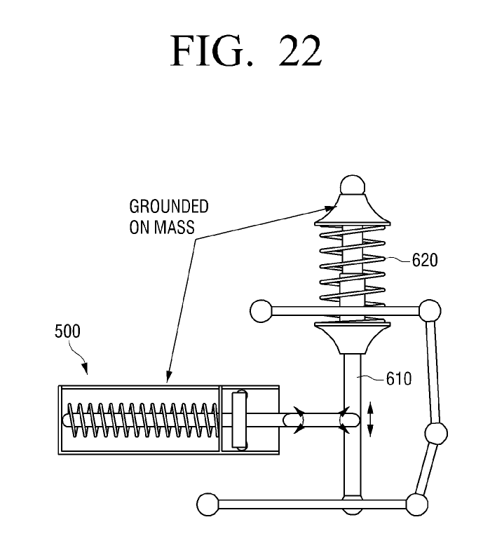

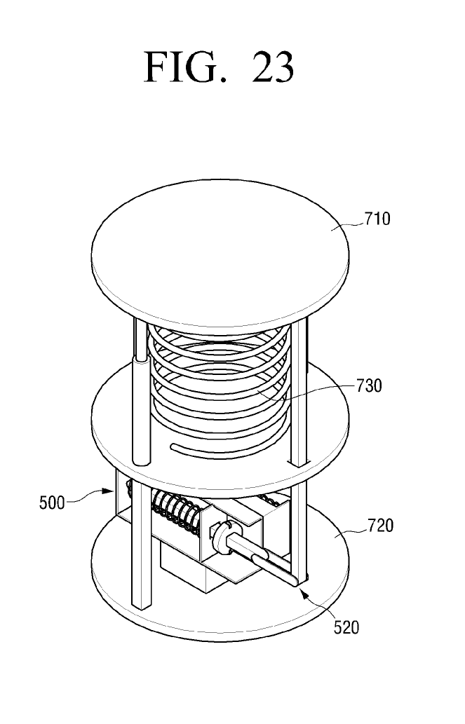

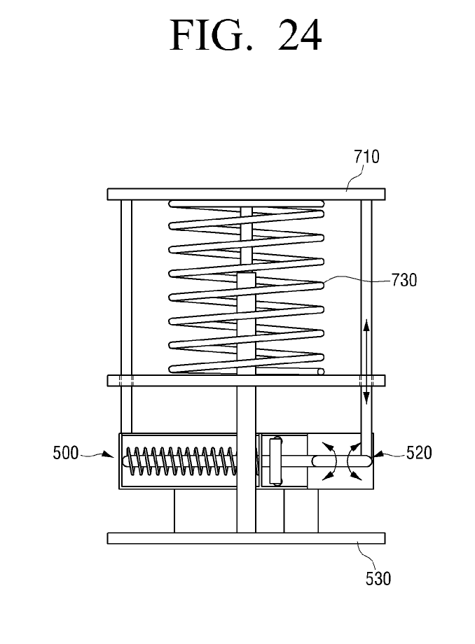

FIGS. 14 through 18 are perspective views illustrating a structure and an operation principle of the vibration isolation system of FIG. 4 which is applied to a suspension used for a driver's seat and a main suspension of a vehicle, according to embodiments of the present invention. FIGS. 19 and 20 are respectively a perspective view and a front view illustrating a structure of the vibration isolation system of FIG. 4 which is installed on a side of an axle of a Mcperson type suspension. FIGS. 21 and 22 are respectively a perspective view and a front view illustrating a structure of the vibration isolation system of FIG. 4 which is installed on a side of an axle of a Wish-bone type suspension. FIGS. 23 and 24 are respectively a perspective view and a front view illustrating a structure and an operation principle of a vibration isolation system used for a machinery installation table to which the operation principle of the vibration isolation system of FIG. 4 is applied.

An X axis of FIG. 5 denotes a magnitude of a displacement caused by vibrations transmitted to the vibration isolation system of the present invention, and a Y axis of FIG. 5 denotes a magnitude of potential energy. Also, A denotes a change curve of potential energy of a main spring, and B denotes a change curve of potential energy of an auxiliary spring. C denotes a change curve of whole potential energy of the vibration isolation system of the present invention that is a sum of the potential energies of the main spring and the auxiliary spring.

The structure and the operation principle of the vibration isolation system having the low natural frequency according to the present invention will now be described with reference to FIGS. 4 through 13.

As shown in FIG. 4, a vibration isolation system 400 having a low natural frequency (hereinafter referred to as a vibration isolation system) according to the present invention includes a first object 410, a second object 420, a main spring 430, and a negative stiffness device 500. Alternatively, the vibration isolation system 400 may further include a damper 440 having a constant damping value.

For reference, the low natural frequency refers to a natural frequency of a vibration isolation system which is theoretically lowered to 0 Hz and substantially lowered to be less than or equal to 1 Hz, i.e., to be close to 0 Hz.

The first and second objects 410 and 420 refer to parts of objects which receive vibrations and shocks. The objects may include devices and equipment which receive vibrations and shocks, i.e., vehicles, motorcycles, aircrafts, construction equipment, elevators, and all types of devices and equipment in which an existing vibration isolation device for relieving vibrations and shocks can be installed.

The main spring 430 is located between the first and second objects 410 and 420 to relieve vibrations and shocks which are transmitted from one of the first and second objects 410 and 420 to the other one of the first and second objects 410 and 420.

Here, the change curve A of FIG. 5 indicates a change curve of potential energy of the main spring 430, i.e., a potential energy function of the main spring 430 with respect to a relative displacement between the first and second objects 410 and 420. The change curve B indicates a change curve of potential energy of an auxiliary spring 510, i.e., a potential energy function of the auxiliary spring 510 of the negative stiffness device 500.

The change curve C indicates a change curve of whole potential energy of the vibration isolation system 400 which is a sum of the change curves A and B, i.e., a sum of the potential energies of the main spring 430 and the auxiliary spring 510.

As seen from the change curve A (the change curve of the potential energy of the main spring 430) of FIG. 5, the potential energy of the main spring 430 changes at a positive (+) change rate according to relative displacements of the first and second objects 410 and 420 of the vibration isolation system 400.

If the main spring 430 is disposed in a neutral position in which up and down vibrations are not transmitted to the vibration isolation system 400, the potential energy of the main spring 430 has a minimum value at a static deflection in which a weight supported by the first object 410 and a force of the main spring 430 are balanced.

If a dynamic load is applied to the vibration isolation system 400 due to vibrations and shocks, the main spring 430 gets out of the neutral position, and thus the potential energy of the main spring 430 increases.

The negative stiffness device 500 includes the auxiliary spring 510, a link part 520, and a support part 530. The negative stiffness device 500 is a passive type additional device which is additionally installed in a passive type vibration isolation system, which does not require external power, to improve vibration isolation efficiency of vibrations.

The link part 520 is located between the first and second objects 410 and 420, and end of the link part 520 is fixedly installed on a side of the first object 410 so that the link part 520 moves up and down with a movement of the first object 410, and an other end of the link part 520 is connected to an end of the auxiliary spring 510.

An end of the support 530 is fixedly installed on a side of the second object 420, and an other end of the support part 530 fixes an other end of the auxiliary spring 510.

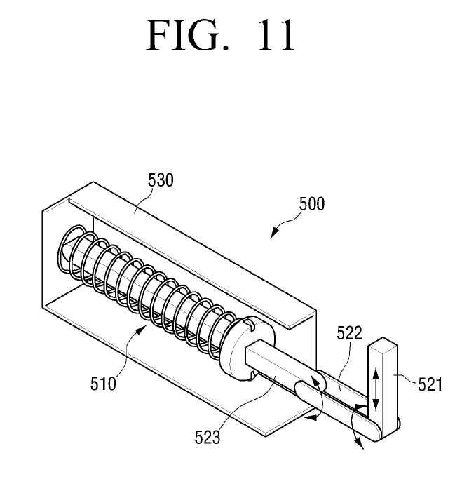

The auxiliary spring 510 has maximum potential energy in the neutral position (refer to FIG. 5). As the relative positions of the first and second objects 410 and 420 deviate from the neutral position, the potential energy of the auxiliary spring 510 changes at a negative (−) change rate. The auxiliary spring 510 may include a tension spring or a compression spring. An exemplary embodiment using the tension spring correspond to FIGS. 6 through 10, and an exemplary embodiment using the compression spring correspond to FIGS. 11 through 13. For convenience of explanation, the auxiliary spring 510 will be described as the tension spring.

An end of the auxiliary spring 510 is connected to the link part 520, and an other end of the auxiliary spring 510 is connected to an other end of the support part 530. Therefore, when the link part 520 moves up and down along with the first object 410, a tension displacement of the auxiliary spring 510 changes. This indicates that the auxiliary spring 510 is initially installed in a maximum tension state, and when up and down vibrations are transmitted to the vibration isolation system 400, an initial tension displacement of the auxiliary spring 510 changes due to up and down relative motions of the first and second objects 520.

Referring to FIG. 5, as seen from the change curve B of the potential energy of the auxiliary spring 510, the potential energy of the auxiliary spring 510 changes according to magnitudes of vibrations transmitted to the vibration isolation system 400.

In other words, since the auxiliary spring 510 is maximally tensed in the neutral position that has a static load state in which the up and down vibrations are not transmitted to the vibration isolation system 400, the potential energy of the auxiliary spring 510 maintains a maximum magnitude. If the up and down vibrations are transmitted to the vibration isolation system 400, the tension displacement of the auxiliary spring 510 decreases, thereby decreasing the potential energy of the auxiliary spring 510

If the auxiliary spring 510 is the compression spring (refer to FIGS. 11 through 13), the auxiliary spring 510 is maximally compressed in the neutral position. However, changes in the potential energy of the auxiliary spring 510 which is the compression spring are similar to those of the potential energy of the auxiliary spring 510 which is the tension spring.

As shown in FIGS. 6 through 13, the negative stiffness device 500 may be installed with various structures in the vibration isolation system 400 by changing shapes of the link part 520 and the support part 530 which are located between the first and second objects 410 and 420.

Referring to FIGS. 6 through 13, the link part 520 may include first, second, and third links 521, 522, and 523, a circular link 524, and a roller 525. A function of the link part 520 may be performed by combinations of a plurality of links or a roller selected from the first, second, and third links 521, 522, and 523 and the circular link 524 or the roller 525.

The potential energy of the vibration isolation system 400 changes more gently than that of a conventional vibration isolation system including only a main spring, regardless of shapes and installation positions of the link part 520 and the support part 530. Therefore, the natural frequency of the vibration isolation system 400 is lowered to be less than or equal to 1 Hz, i.e., to be close to 0 Hz, according to a demand of a design value.

The embodiments of FIGS. 6 through 13 will now be described in more detail.

FIG. 6 is a perspective view illustrating the auxiliary spring 510 which is a tension spring that is maximally tensed in a neutral position, according to an embodiment of the present invention. The firs link 521 is fixed to the first object 410 to move in the same direction (i.e., an up and down direction) as a movement direction of the first object 410. An end of the second link 522 is connected to the first link 521. An end of the third link 523 is connected to the second link 522, an other end of the third link 523 is connected to an end of the auxiliary spring 510, and an other end of the auxiliary spring 510 is fixed. The second line 522 changes the movement direction of the first link 521, and thus the third link 523 moves in a different direction (i.e., a horizontal direction) from the movement direction of the first direction 521.

In this case, since the auxiliary spring 510 is maximally tensed in the neutral position as shown in FIG. 6, the potential energy of the auxiliary spring 510 is maximized. If a position of the first object 410 changes from the neutral position, the third link 523 moves to the right side in FIG. 6, thereby decreasing a tension displacement of the auxiliary spring 510. This indicates a decrease in the potential energy of the auxiliary spring 510. Therefore, the potential energy of the auxiliary spring 510 changes as shown in FIG. 5. As described above, the change rate of the whole potential energy of the vibration isolation system 400 may be gentler than the conventional vibration isolation system according to the change in the potential energy of the auxiliary spring 510. This indicates that the natural frequency of the vibration isolation system 400 is lowered.

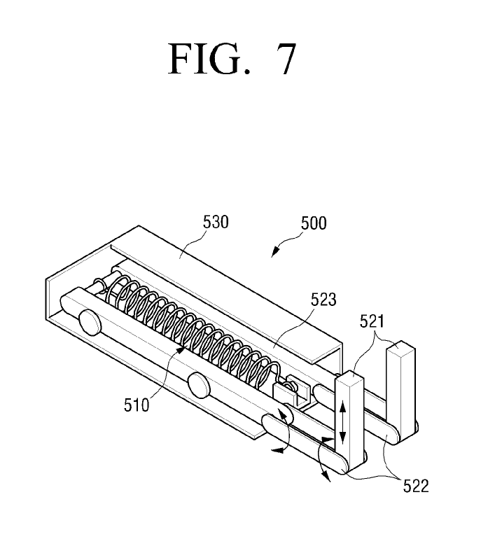

FIG. 7 is a perspective view illustrating another embodiment of the present invention in which the auxiliary spring 510 is the tension spring. The present embodiment of FIG. 7 is almost similar to the embodiment of FIG. 6 except that the third link 523 includes wheels to help smooth movement of the third link 523, and thus its detailed descriptions will be omitted herein.

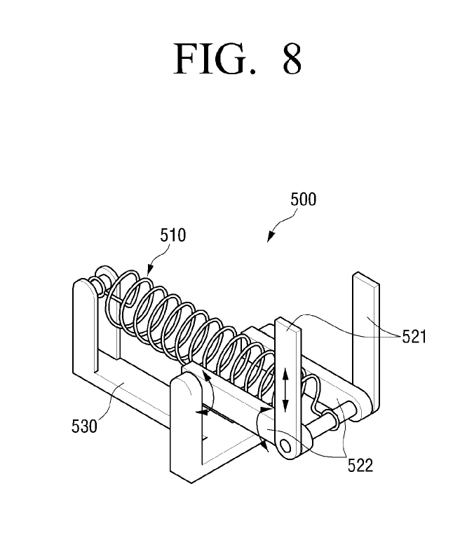

FIG. 8 is a perspective view illustrating another embodiment of the present invention in which the auxiliary spring 510 is the tension spring that is maximally tensed in the neutral position. Here, only two links, i.e., only the first and second links 521 and 522, are used. The first link 521 is pivotably connected to the first object 410, and the second link 522 is connected to the first link 521. A connection part of the first link 521 to the first object 410 is not shown in FIG. 8. Since an end of the second link 522 is pivotably fixed, the second link 522 pivots on the pivotably fixed end thereof when the first object 410 moves.

An end of the auxiliary spring 510 is connected to an other end of the second link 522, and an other end of the auxiliary spring 510 is pivotably fixed. Only lengths of the auxiliary springs 510 of FIGS. 6 and 7 change, but a length of the auxiliary spring 510 of FIG. 8 changes as the auxiliary spring 510 pivots. This is because the third link 523 shown in FIGS. 6 and 7 is omitted in the present embodiment of FIG. 8.

The pivotably fixed end of the second link 522 is disposed in a position in which the auxiliary spring 510 is maximally tensed in the neutral position. In other words, when the auxiliary spring 510 is in the neutral position as shown in FIG. 8, a position of the end of the second link 522 is disposed between the end and the other end of the auxiliary spring 510. Since the auxiliary spring 510 is maximally tensed in the neutral position as shown in FIG. 8, the potential energy of the auxiliary spring 510 is maximized. If the position of the first object 410 deviates from the neutral position, the second link 522 pivots on the end thereof, and the tension displacement of the auxiliary spring 510 decreases. This indicates a decrease in the potential energy of the auxiliary spring 510. Therefore, the potential energy of the auxiliary spring 510 changes as shown in FIG. 5.

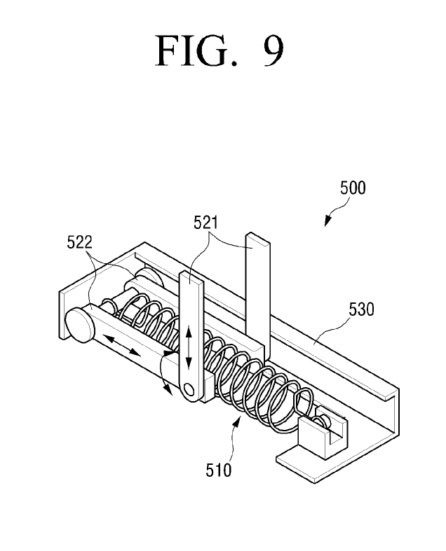

FIG. 9 is a perspective view illustrating another embodiment of the present invention in which the auxiliary spring 510 is the tension spring. The present embodiment of FIG. 9 is almost similar to the embodiments of FIGS. 6 and 7 except that a position of the first link 521 is changed. Since the first link 521 is disposed between an end and an other end of the auxiliary spring 510, an occupied volume of the negative stiffness device 500 decreases, thereby reducing a size of the negative device 500.

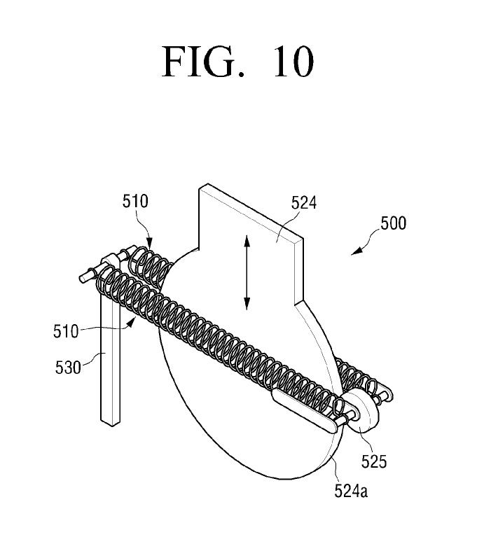

FIG. 10 is a perspective view illustrating another embodiment of the present invention in which the auxiliary spring 510 is the tension spring that is maximally tensed in the neutral position. The present embodiment of FIG. 10 is similar to the embodiments of FIGS. 6 through 9 except that the circular link 524 having a curved part 524a is used.

The circular link 524 is fixed to the first object 410 to move in the same direction (i.e., an up and down direction) as the movement direction of the first object 410. An end of the auxiliary spring 510 contacts the curved part 524a of the circular link 524 through the roller 525, and an other end of the auxiliary spring 510 is fixed. Therefore, the auxiliary spring 510 is horizontally displaced. Here, the tension displacement of the auxiliary spring 510 is determined by a shape of the curved part 524a.

Therefore, the curved part 524 is formed so that the auxiliary spring 510 is maximally tensed in the neutral position. For example, as shown in FIG. 10, the curved part 524 may have an arc shape. In this case, since the auxiliary spring 510 is maximally tensed in the neutral position as shown in FIG. 10, the potential energy of the auxiliary spring 510 is maximized. If the position of the first object 410 deviates from the neutral position, the tension displacement of the auxiliary spring 510 decreases. This indicates a decrease in the potential energy of the auxiliary spring 510. Therefore, the potential energy of the auxiliary spring 510 changes as shown in FIG. 5.

FIG. 11 is a perspective view illustrating another embodiment of the present invention in which the auxiliary spring 510 is a compression spring that is maximally compressed in the neutral position. First, second, and third lines 521, 522, and 523 of FIG. 11 have similar structures to those of the first, second, and third lines 521, 522, and 523 of FIG. 6. However, the auxiliary spring 510 is the compression spring, and a fixed position of the auxiliary spring 510 is changed. Referring to FIG. 11, a left end of the auxiliary spring 510 is fixed. A right end of the auxiliary spring 510 is connected to the third link 523 to move according to a movement of the third link 523.

In this case, since the auxiliary spring 510 is maximally compressed in the neutral position as shown in FIG. 11, the potential energy of the auxiliary spring 510 is maximized. If the position of the first object 410 deviates from the neutral position, the third link 523 moves to the right side in FIG. 11, and thus the right end of the auxiliary spring 510 also moves to the right side. This indicates that the potential energy of the auxiliary spring 510 decreases with a decrease in a compression displacement of the auxiliary spring 510. Therefore, the potential energy of the auxiliary spring 510 changes as shown in FIG. 5.

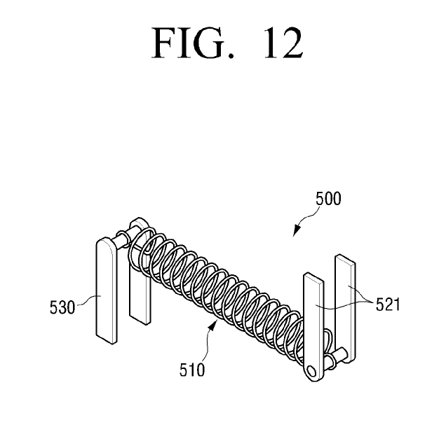

FIG. 12 is a perspective view illustrating another embodiment of the present invention in which the auxiliary spring 510 is the compression spring that is maximally compressed in the neutral position. Here, only one link, i.e., only the first link 521, is used. The first link 521 is fixed to the first object 410 to move in the same direction (i.e., an up and down direction) as the movement direction of the first object 410. An end of the auxiliary spring 510 is connected to the first link 521, and an other end of the auxiliary spring 510 is pivotably fixed. Therefore, if the first object 410 moves, the auxiliary spring 510 pivots to be displaced.

Since the auxiliary spring 510 is maximally compressed in the neutral position as shown in FIG. 12, the potential energy of the auxiliary spring 510 is maximized. If the position of the first object 410 deviates from the neutral position, the end of the auxiliary spring 510 moves up and down, thereby decreasing the compression displacement of the auxiliary spring 510. This indicates a decrease in the potential energy of the auxiliary spring 510, and the potential energy of the auxiliary spring 510 changes as shown in FIG. 5.

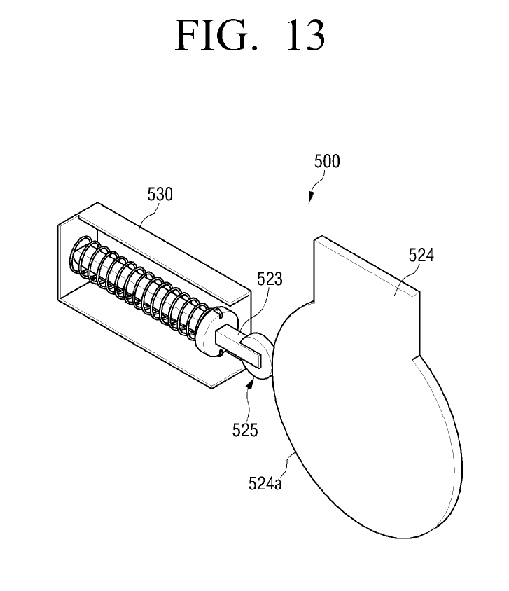

FIG. 13 is a perspective view illustrating another embodiment of the present invention in which the auxiliary spring 510 is the compression spring that is maximally compressed in the neutral position. The present embodiment of FIG. 13 is the same as the embodiment of FIG. 10 in that the circular link 524 having the curved part 524 is used, and thus its detailed descriptions will be omitted herein. However, in the present embodiment, the auxiliary spring 510 is maximally compressed in the neutral position, and when the position of the first object 410 deviates from the neutral position, the compression displacement of the auxiliary spring 510 decreases. Therefore, the potential energy of the auxiliary spring 510 changes as shown in FIG. 5.

A structure and an operation principle of the vibration isolation system 400, which is applied to a driver's seat or a passenger's seat of a vehicle to isolate vibrations transmitted to the driver's seat or the passenger's seat, will now be described.

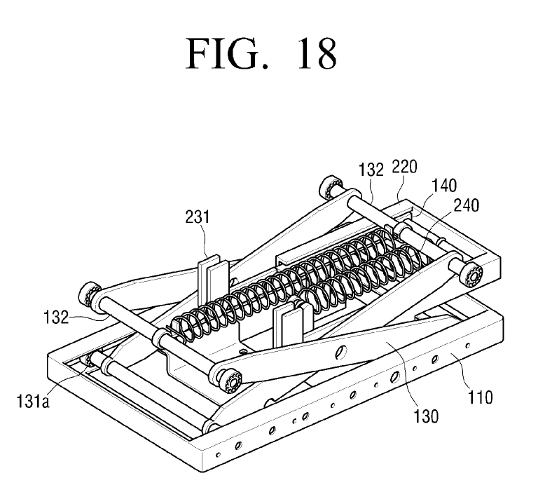

Referring to FIGS. 14 and 18, a vibration isolation system according to an embodiment of the present invention includes a lower rail guide 110, an upper rail guide 120, a support link 130, a main spring 140, and a negative stiffness device 200.

The upper rail guide 120 is connected to a side of a first object, and the lower rail guide 110 is connected to a side of a second object.

Here, the first and second objects refer to parts of objects which receive vibrations and shocks. The objects may include devices and equipment which receive vibrations and shocks, i.e., vehicles, motorcycles, aircrafts, construction equipment, elevators, and all types of devices and equipment in which an existing vibration isolation device for relieving vibrations and shocks can be installed.

The lower rail guide 110 is fixedly installed in a vehicle body, and link connection parts 131a are respectively installed at corners of the lower rail guide 110 to be connected to a lower part of the support link 130.

The upper rail guide 120 is located above the lower rail guide 110 and has an upper surface on which a seat cushion (not shown) is installed. The upper rail guide 120 includes a fixed plate 121 which supports an end of the main spring 140, and link connection parts 131b are respectively formed at corners of the upper rail guide 120 to be connected to an upper part of the support link 130.

The support link 130 is located between the lower and upper rail guides 110 and 120 so that the lower part of the support link 130 is combined with the link connection parts 131a of the lower rail guide 100, and the upper part of the support link 130 is combined with the link connection parts 131b of the upper rail guide 120. Also, the support link 130 is installed to connect the lower and upper rail guides 110 and 120 to each other in order to move the upper rail guide 120 up and down based on the lower rail guide 110.

Also, the support link 130 is formed in an X shape in which two links intersect with each other. The two links are joined at a central part in which the two links intersects with each other so that a height of the support link 130 is adjusted. In general, two or more support links 130 may be installed, but the present invention is not limited thereto. The number of support links 130 may be determined in consideration of a use of the vibration isolation system of the present invention or a magnitude of a load applied to a suspension system.

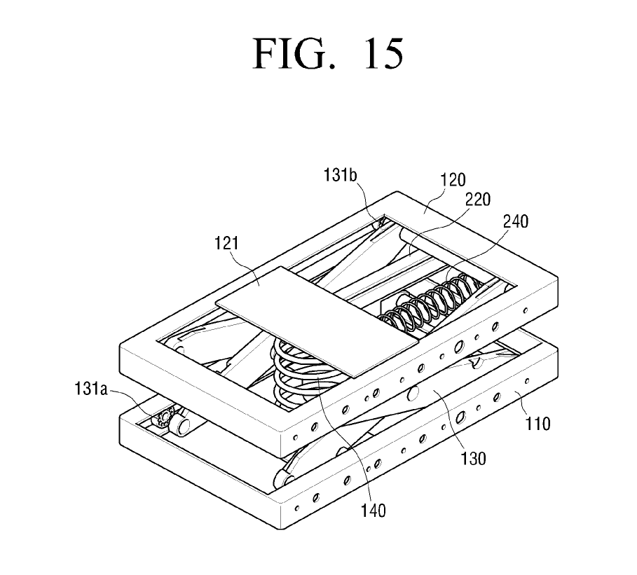

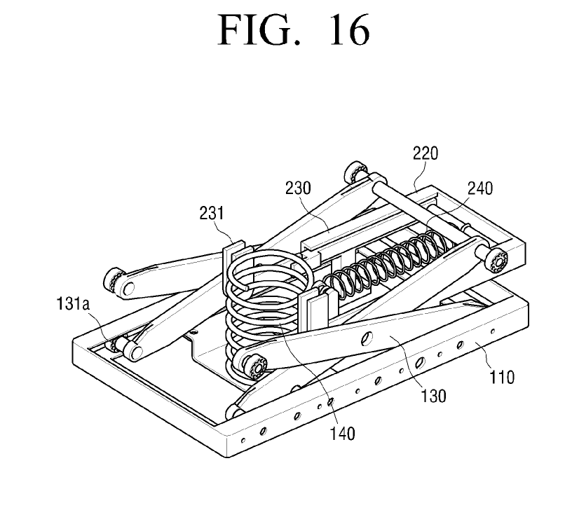

An installation position of the main spring 140 changes with a shape thereof. If the main spring 140 has a shape as shown in FIGS. 15 and 16, the main spring 140 is vertically installed. Therefore, an end of the main spring 140 is supported by and fixed onto an upper surface of the lower rail guide 110, and an other end of the main spring 140 is supported by and fixed onto a lower surface of the upper rail guide 120.

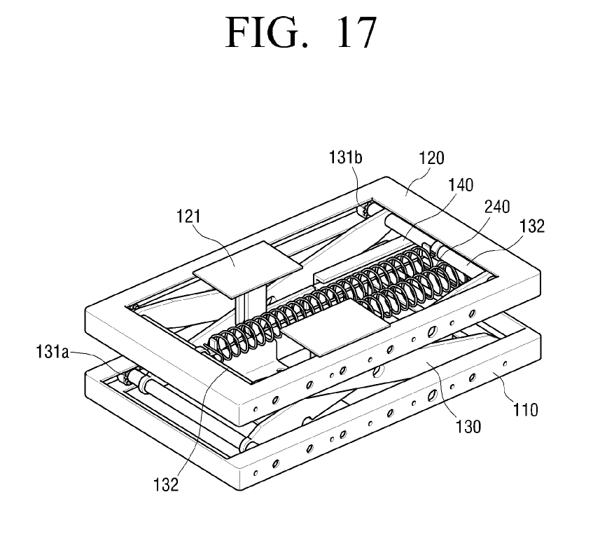

If the main spring 141 has a shape as shown in FIGS. 17 and 18, the main spring 140 is horizontally installed so that both ends of the mains spring 140 are respectively fixedly installed to left and right link rotation rollers 132 of the support link 130.

As described above, the main spring 140 is located between the lower and upper rail guides 110 and 120 to buffer vibrations transmitted from the vehicle body.

An air spring, a plate spring, or the like may be used as the main spring 140 in consideration of the use of the vibration isolation system of the present invention, a magnitude of load of applied vibrations, and environments.

Here, referring to FIG. 5, as seen from the change curve A (the change curve of the potential energy of the main spring 140), the potential energy of the main spring 140 changes at a positive change rate according to relative displacements of upper and lower frames of the vibration isolation system of the present invention.

In other words, the potential energy of the main spring 140 has a minimum value in the neutral position in which up and down vibrations are not transmitted to the suspension system of the present invention, i.e., in a static deflection state in which a weight of a driver sitting on a seat and a force of a spring are balanced.

If a dynamic load is applied to the vibration isolation system, the main spring 140 deviates from the neutral position, thereby increasing the potential energy thereof.

As shown in FIG. 14, the negative stiffness device 200 includes a support plate 210, a link housing 220, a link part 230, and an auxiliary spring 240.

The support plate 210 may be directly fixedly installed in a vehicle body so that the negative stiffness device 200 is supported and fixed by the vehicle body. Alternatively, the support plate 210 may be fixedly installed onto an upper surface of the lower rail guide 110 which is installed and fixed to the vehicle body.

The link housing 220 is fixedly installed on an upper surface of the support plate 210 and includes a guide part 221. The link part 230 is inserted into the guide part 221 of the link housing 220 and includes first, second, and third links 231, 232, and 233.

The third link 233 is inserted into the guide part 221 and slides inside the guide part 221 to horizontally move back and forth. An end of the first link 231 is supported by and fixedly installed on a side of the fixed plate 121 of the upper rail guide 120 to move up and down with a movement of the upper rail guide 120.

The second link 232 connects the first and second links 231 and 233 to each other so that the third link 233 horizontally moves back and forth with the up and down movements of the first link 231.

The second link 232 connected to the first link 231 pulls the third link 233 in a direction indicated by an arrow of the FIG. 14 in response to the up and down movements of the first link 231, thereby changing a tension displacement of the auxiliary spring 240.

An end of the auxiliary spring 240 is connected to a side of the link part 230, and an other end of the auxiliary spring 240 is connected to a side of the support plate 210, so that the tension displacement of the auxiliary spring 240 changes with the horizontally back and forth movements of the third link 233 of the link part 230.

This indicates that the auxiliary spring 240 is initially installed to be maximally tensed or compressed, and thus an initial tension or compression displacement is relieved due to up and down relative motions of the upper and lower rail guides 120 and 110.

In other words, if up and down vibrations are transmitted to the vibration isolation system of the present invention, the upper rail guide 120 moves up and down, and thus the first link 231 fixed to the fixed plate 121 of the upper rail guide 120 moves up and down together. Therefore, the second link 232 connected to the first link 231 operates to horizontally move the third link 233 back and forth.

Here, referring to FIG. 5, as seen from the change curve B of the potential energy of the auxiliary spring 240, the potential energy of the auxiliary spring 240 changes according to a magnitude of vibrations transmitted to the vibration isolation system of the present invention.

Since the auxiliary spring 240 is maximally tensed in the neutral position that is a static load state in which the up and down vibrations are not transmitted to the vibration isolation system of the present invention, the potential energy of the auxiliary spring 240 maintains a maximum magnitude. If the up and down vibrations are transmitted to the vibration isolation system, the tension displacement of the auxiliary spring 240 decreases more than in the neutral position. Therefore, the auxiliary spring 240 gets out of the maximum tension state, and thus the potential energy of the auxiliary spring 240 decreases.

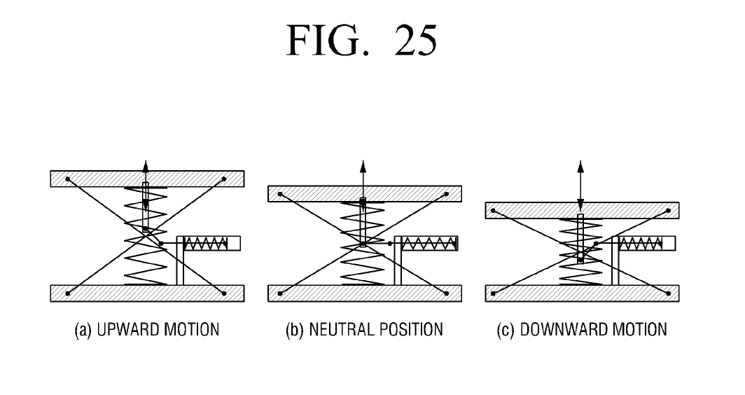

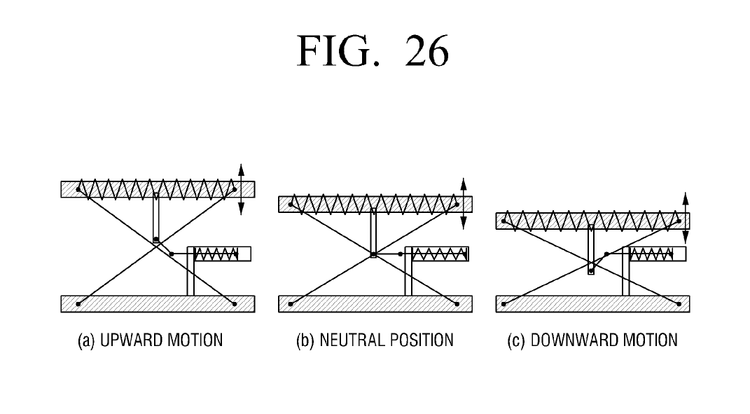

FIG. 25 is a schematic view illustrating an operation principle of a vibration isolation system in which the main spring 140 of FIGS. 15 and 16 is vertically installed. FIG. 26 is a schematic view illustrating an operation principle of a vibration isolation system in which the main spring 140 of FIGS. 17 and 8 is horizontally installed.

FIGS. 25(a) and 26(a) are views schematically illustrating structures of the main spring 140, the auxiliary spring 240, and the link part 230 which operate when the upper rail guide 120 moves upwards due to an upward vibration transmitted to the vibration isolation system. FIGS. 25(b) and 26(b) are views schematically illustrating structures of the main spring 140 and the auxiliary spring 240 which are disposed in a neutral position when vibrations are not transmitted to the vibration isolation system. FIGS. 25(c) and 26(c) are views schematically illustrating structures of the main spring 140, the auxiliary spring 240, and the link part 230 which operate when the upper rail guide 120 moves downwards due to a downward vibration transmitted to the vibration isolation system.

If a vibration is not transmitted to the vibration isolation system as shown in FIG. 25(b), the main spring 140 and the auxiliary spring 240 are disposed in the neutral position. Therefore, the potential energy of the main spring 140 maintains a minimum value, and the potential energy of the auxiliary spring 240 maintains a maximum value as shown in FIG. 5.

The potential energy of the auxiliary spring 240 has the maximum value, but a sum of the potential energies of the main spring 140 and the auxiliary spring 240, i.e., a sum of the whole potential energy of the vibration isolation system, has a minimum value. Therefore, the neutral position is maintained as described above.

Here, the neutral position refers to a state in which the main spring 140 is in a static deflection state, and the auxiliary spring 240 maintains a maximum tension displacement, i.e., a state in which the second and third links 232 and 233 of the link part 230 keep horizontal.

If drivers having different weights sit on a seat in which the vibration isolation system of the present invention is installed, the weight of the drivers affect displacements of the main spring 140 and the auxiliary spring 240, thereby changing the neutral position.

If the neutral position changes according to a weight of a driver as described above, a minimum potential energy position of the main spring 140 and a maximum potential energy position of the auxiliary spring 240 do not agree with each other. Therefore, an original characteristic of the vibration isolation system is not maximized.

Therefore, if the vibration isolation system of the present invention is applied, the vibration isolation system is required to be designed so that the minimum potential energy position of the main spring 140 and the maximum potential energy of the auxiliary spring 240 agree with each other in the neutral position regardless of the weight of the drivers.

If the upward vibration is transmitted to the vibration isolation system as shown in FIG. 25(a), the upper rail guide 120 rises. Therefore, a compression displacement of the main spring 140 decreases more than in the neutral position due to an elastic force of the main spring 140. Also, a tension displacement of the auxiliary spring 240 decreases more than in the neutral position due to the link part 230 connected to the upper rail guide 120.

Therefore, if the compression displacement of the main spring 140 decreases, and the tension displacement of the auxiliary spring 240 decreases, the potential energy of the main spring 140 increases in response to a magnitude of a vibration transmitted to the main spring 140 as shown in FIG. 5. Also, the potential energy of the auxiliary spring 240 which has the maximum value in the neutral position decreases in response to a magnitude of a vibration transmitted to the auxiliary spring 240 as shown in FIG. 5.

If a downward vibration is transmitted to the vibration isolation system of the present invention as shown in FIG. 25(c), the upper rail guide 120 goes downwards. Therefore, the main spring 140 is further compressed by the upper rail guide 120, and thus the compression displacement of the main spring 140 increases more than in the neutral position. Also, the tension displacement of the auxiliary spring 240 decreases more than in the neutral position due to the link part 230.

Therefore, in this case, as shown in FIG. 5, the potential energy of the main spring 140 increases in proportion to the magnitude of the transmitted vibration, and the potential energy of the auxiliary spring 240 decreases in proportion to the magnitude of the transmitted vibration.

In other words, in the negative stiffness device 200, changes in the potential energy of the main spring 140 increase according to an amount of the compression or tension displacement of the main spring 140. However, changes in the potential energy of the auxiliary spring 240 decrease according to the amount of the compression or tension displacement.

As described above, if up and down vibrations are not transmitted to the vibration isolation system of the present invention, the vertical type main spring 140 has minimum potential energy. If the upward and downward vibrations are transmitted to the vibration isolation system, a length of the vertical type main spring 140 is compressed or tensed, and thus the potential energy of the vertical type main spring 140 increases at all times.

If the up and down vibrations are not transmitted to the vibration isolation system of the present invention, the auxiliary spring 240 has maximum potential energy. If the upward and downward vibrations are transmitted to the vibration isolation system, a length of the auxiliary spring 240 is compressed at all times, and thus the potential energy of the auxiliary spring 240 decreases at all times.

The change curve C of FIG. 5C which indicates the sum of the potential energies of the main spring 140 and the auxiliary spring 240 shows a lower change rate than the change curve A of FIG. 5, which indicates the potential energy of the main spring 140 of the vibration isolation system, with respect to the displacement.

The main spring 140 which is the horizontal type will now be described with reference to FIG. 26. If a vibration is not transmitted to the vibration isolation system as shown in FIG. 26(b), the main spring 140 and the auxiliary spring 240 are disposed in the neutral position. Therefore, as shown in FIG. 5, the potential energy of the main spring 140 maintains a minimum value, and the potential energy of the auxiliary spring 240 maintains a maximum value.

If an upward vibration is transmitted to the vibration isolation system of the present invention as shown in FIG. 26(a), the upper rail guide 120 rises. Therefore, the main spring 140 is compressed in a longitudinal direction thereof by the support link 130, i.e., an X-shaped link which stretches up and down. Accordingly, the tension displacement of the main spring 140 decreases more than in the neutral position, and the tension displacement of the auxiliary spring 240 decreases more than in the neutral position due to the link part 230.

Accordingly, as shown in FIG. 5, the potential energy of the main spring 140 increases in response to the magnitude of the transmitted vibration, and the potential energy of the auxiliary spring 240 which has the maximum value in the neutral position decreases in response to the magnitude of the transmitted vibration.

If a downward vibration is transmitted to the vibration isolation system as shown in FIG. 26(c), the upper rail guide 120 goes downwards. Therefore, the main spring 140 stretches in the longitudinal direction thereof by the support link 130, i.e., the X-shaped link which shrinks up and down. As a result, the tension displacement of the main spring 140 increases more than in the neutral position, and the tension displacement of the auxiliary spring 240 decreases more than in the neutral position due to the link part 230.

As the tension displacement of the main spring 140 increases and the tension displacement of the auxiliary spring 240 decreases, the potential energy of the main spring 140 increases in response to the magnitude of the transmitted vibration, and the potential energy of the auxiliary spring 240 which has the maximum value in the neutral position decreases in response to the magnitude of the transmitted vibration as shown in FIG. 5.

If the upward and downward vibrations are not transmitted to the vibration isolation system of the present invention as described above, the horizontal type main spring 140 has minimum potential energy. If the upward and downward vibrations are transmitted to the vibration isolation system, the length of the horizontal type main spring 140 is tensed or compressed, thereby increasing the potential energy of the horizontal main spring 140 at all times.

If the upward and downward vibrations are not transmitted to the vibration isolation system, the auxiliary spring 240 has maximum potential energy. If the upward and downward vibrations are transmitted to the vibration isolation system, the length of the auxiliary spring 240 is compressed at all times, and thus the potential energy of the auxiliary spring 240 decreases at all times.

Accordingly, even if the vibration isolation system includes the horizontal type main spring, the sum of the potential energies of the main spring 140 and the auxiliary spring 240 has a characteristic in which the change rates of the sum of the potential energies of the main and auxiliary springs 140 and 240 decrease as in the vertical type suspension system described with reference to FIG. 25.

As described above, the change rate of the potential energy of the vibration isolation system with respect to the displacement decreases regardless of whether the main spring 140 is the vertical or horizontal type. Therefore, a natural frequency of the vibration isolation system is lowered to be less than or equal to 1 Hz according to a design value.

In other words, in the vibration isolation system of the present invention, the change rate of the potential energy of the auxiliary spring 240 which is a linear spring decreases the change rate of the whole potential energy of the vibration isolation system. Therefore, an exchange rate of the potential energy of the vibration isolation system per time with respect to whole kinetic energy of the vibration isolation system decreases, thereby lowering the natural frequency of the vibration isolation system to be less than or equal to 1 Hz.

In the vibration isolation system of the present invention, a shape and an installation position of the main spring 140, the auxiliary spring 240, and the link part 230 which connects the upper rail guide 120 to the auxiliary spring 240 may be variously changed and designed. Anyway, the change rate of the whole potential energy of the vibration isolation system decreases using a negative stiffness linear spring to lower the natural frequency of the vibration isolation system.

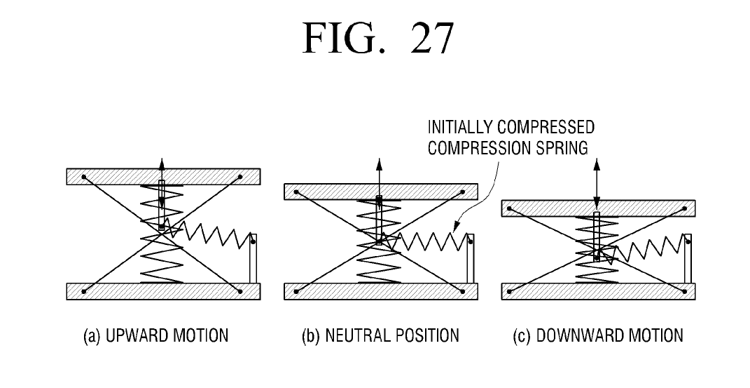

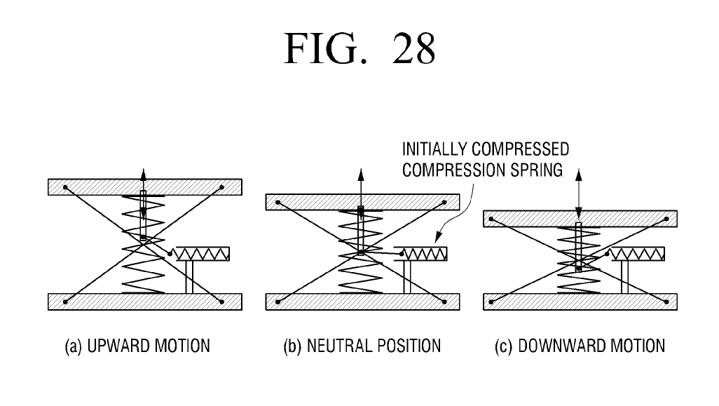

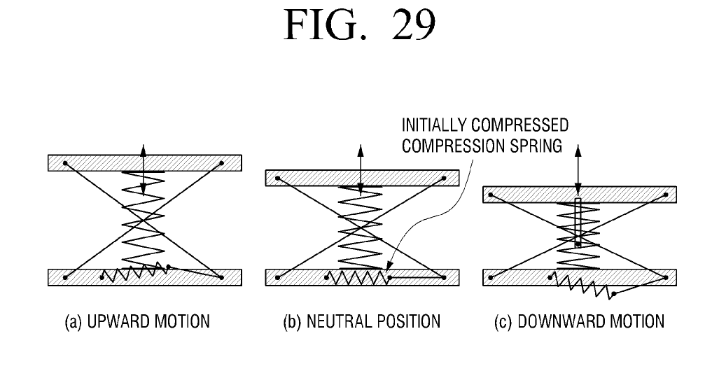

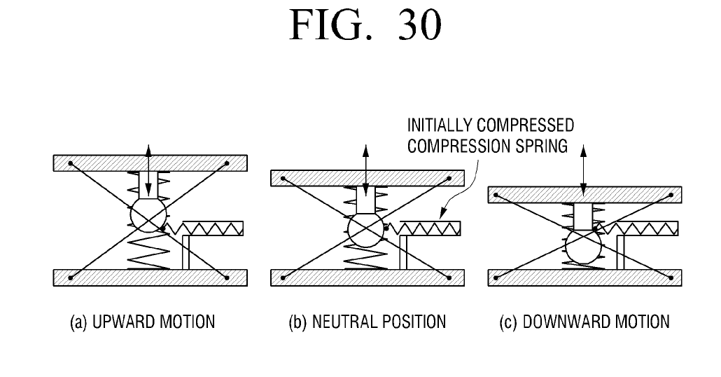

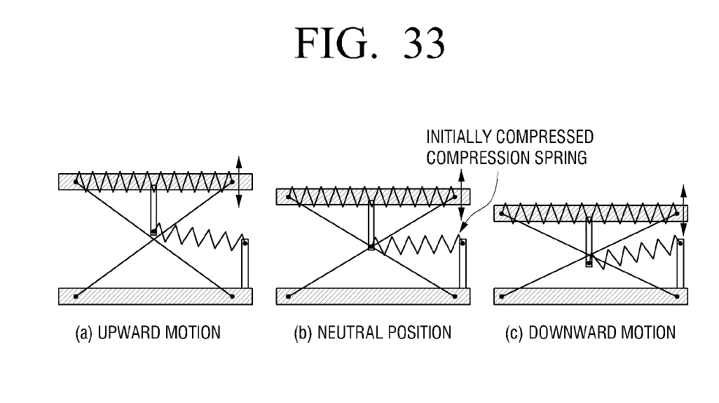

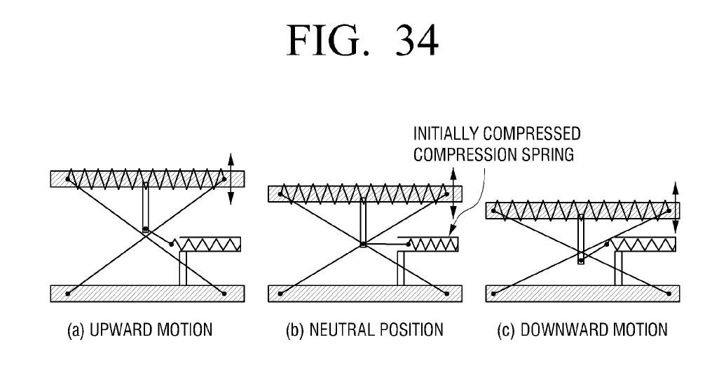

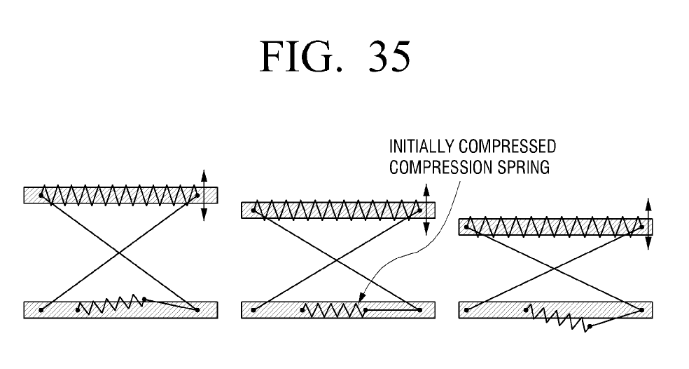

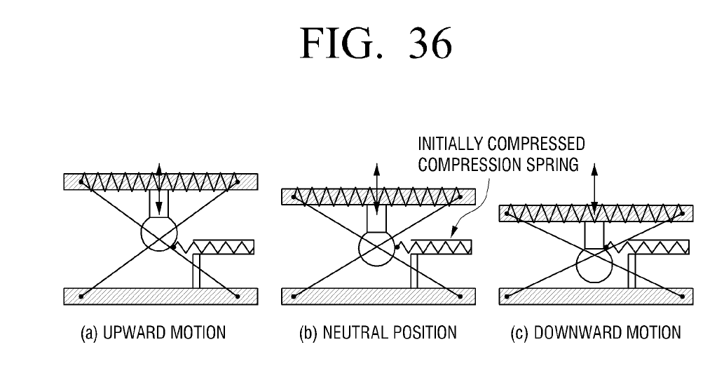

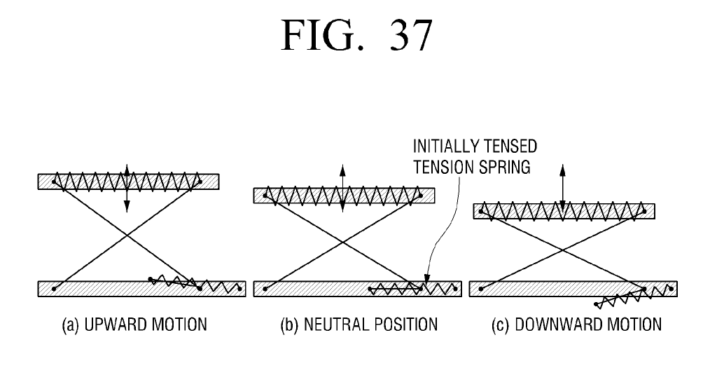

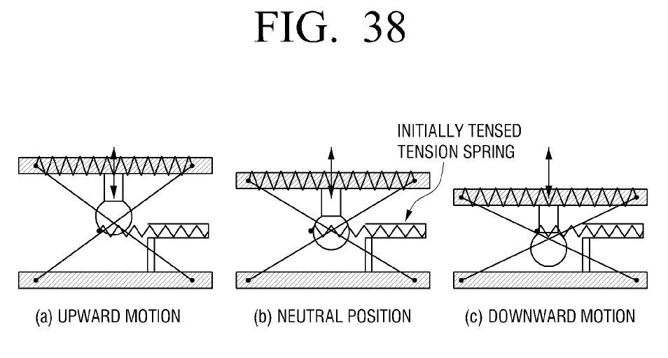

FIGS. 27 through 38 are views illustrating a structure of the vibration isolation system of the present invention by changing a shape of a main spring (whether the main spring is a tension or compression spring), a shape of an auxiliary spring (whether the auxiliary spring is a tension, compression, or a plate spring), and a shape of a link part (whether the link part is divided into first, second, and third links or whether the link part is an angular type or a circular type), and an installation position of the link part (whether the link part is installed at an upper rail guide or a lower rail guide or between the upper and lower rail guides), according to various embodiments of the present invention.

In FIGS. 27 through 38, potential energy of the vibration isolation system of the present invention gently changes regardless of whether a main spring and an auxiliary spring is compression or tension springs and a shape and an installation position of a link part. Therefore, a natural frequency of the vibration isolation system is lowered to be less than or equal to 1 Hz, i.e., to be close to 0 Hz, according to a demand of a design value.

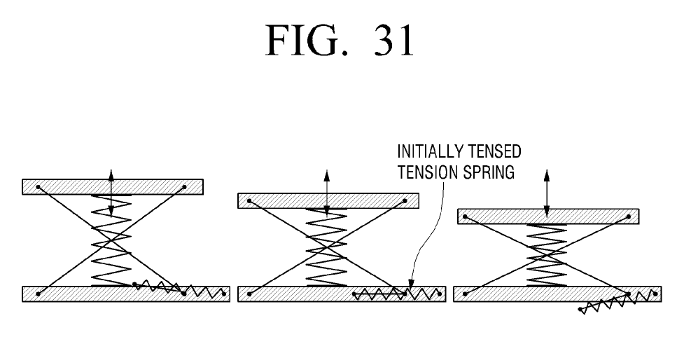

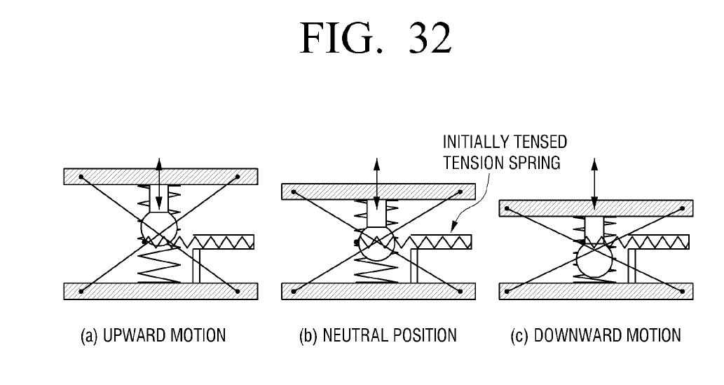

FIGS. 27 through 32 illustrate cases in which the main spring is vertically installed. Referring to FIGS. 27 through 32, a compression spring is used as the auxiliary spring and maximally compressed in a neutral position. In FIGS. 31 through 32, the tension spring is used as the auxiliary spring and maximally tensed in the neutral position. Since various structures of a negative stiffness device has been described with reference to FIGS. 6 through 13, structures shown in FIGS. 27 through 32 will be easily understood by those skilled in the art, and thus their detailed descriptions will be omitted herein.

The vibration isolation system of the present invention has been described as being applied to driver's seats of various types of vehicles, but the present invention is not limited thereto. The vibration isolation system of the present invention may be equally applied to a vehicle suspension system which inhibits vibrations occurring during travelling on the road, a machine support system which supports machines, or the like.

For example, as shown in FIGS. 19 through 22, the negative stiffness device 500 to which the operation principle of the vibration isolation system 400 of the present invention is applied is installed on a side of an axle 610 of a vehicle. Therefore, the negative stiffness device 500 isolates vibrations or shocks transmitted from tires of the vehicle.

Instead of being applied to a vehicle as described above, the vibration isolation system 400 may be applied between a machine, which produces vibrations, and a support, which supports a weight of the machine, to reduce vibrations or shocks produced from the machine as shown in FIGS. 23 and 24. Here, the machine may be located on a first object 710, and the support may be located underneath a second object 720.

Here, potential energy of a main spring 730 increases according to an amount of a tension displacement of the main spring 730 caused by up and down relative motions of the first and second objects 710 and 720. Potential energy of an auxiliary spring of the negative stiffness device 500 decreases in response to the amount of the tension displacement.

In the vibration isolation system installed on an axle of the vehicle and the vibration isolation system installed between the machine and the support of the machine, a change rate of potential energy of the auxiliary spring decreases a change rate of whole potential energy of the vibration isolation system. Therefore, an operation principle of lowering a natural frequency of the vibration isolation system is the same as the operation principle of the vibration isolation system described with reference to FIG. 4, and its additional descriptions will be omitted herein.

In summary, a negative stiffness device is used in an existing vibration isolation system to keep a change rate of potential energy of the existing vibration isolation system low according to a displacement. A negative stiffness device applied to an existing vibration isolation system using only a main spring may be installed in parallel so that a displacement of a spring of the negative stiffness device forms a right angle with a relative displacement between a first object (mass) and a second object (a support) (refer to FIG. 4).

Here, the negative stiffness device may include a linear spring and a link which links a displacement of the linear spring with a relative displacement between first and second objects. Here, since the auxiliary spring is initially installed in a tension or compression state, potential energy of the auxiliary spring decreases when its initial tension or compression displacement is relieved due to relative motions of the first and second objects. A change rate of potential energy of the main spring increases according to an amount of a compression or tension displacement of the main spring of the vibration isolation system. However, the potential energy of the auxiliary spring decreases according to the amount of the compression or tension displacement. Therefore, a change rate of whole potential energy of the vibration isolation system, which is a sum of the potential energies of the main spring and the auxiliary spring, is lowered, and thus a natural frequency of the vibration isolation system is maintained in a very low state. It has been described in the previous embodiment that a tension spring or a compression spring is used as an auxiliary spring. However, besides the tension or compression spring, various types of springs or other elastic members may be used.

The negative stiffness device generally includes a link (the first link 521) which is fixed onto a side of the first object to move up and down with a movement of the first object, a link (the second link 522) which converts the up and down movements of the first link to a horizontal displacement of an auxiliary spring, a spring guide support link (the third link 523) which enables horizontal back and forth displacements of a spring from the first link through the second link, and a support part (a guide 530) which restricts horizontal back and forth motions of the third link. According to a structure of the vibration isolation system, the negative stiffness device may be designed in various structures, including a structure in which the third link is omitted (refer to FIGS. 8 and 9), a structure in which the third link is omitted and the first and second links are combined into one (refer to FIG. 10), a structure in which a spring replaces the first and third links (refer to FIG. 12), a structure in which the first and second links are combined (refer to FIG. 13), etc.

While the invention has been shown and described with reference to certain embodiments thereof, it will be understood by those skilled in the art that various changes in form and detail may be made therein without departing from the spirit and scope of the invention, as defined by the appended claims.

1-46. (canceled)

47. A vibration isolation system comprising:
a first elastic member which buffers vibrations transmitted between first and second objects, which perform relative motions in a first direction, the first elastic member having minimum potential energy at a neutral position;
a second elastic member having potential energy which changes according to relative motions of the first and second objects; and
a link part which connects the first object and the second elastic member so that the potential energy of the second elastic member is maximized in the neutral position.

48. The vibration isolation system as claimed in claim 47, wherein as relative positions of the first and second objects deviate from the neutral position, the potential energy of the first elastic member increases and the potential energy of the second elastic member decreases.

49. The vibration isolation system as claimed in claim 47, wherein whole potential energy of the first and second elastic members are minimized at the neutral position, and
wherein as relative positions of the first and second objects deviate from the neutral position, whole potential energy of the first and second elastic members increases.

50. The vibration isolation system as claimed in claim 47, wherein the second elastic member comprises a compression spring which is maximally compressed at the neutral position.

51. The vibration isolation system as claimed in claim 50, wherein the compression spring is displaced in a second direction different from the first direction.

52. The vibration isolation system as claimed in claim 51, wherein the second direction is perpendicular to the first direction.

53. The vibration isolation system as claimed in claim 50, wherein the compression spring is displaced while pivoting on one end of the compression spring which is pivotably fixed.

54. The vibration isolation system as claimed in claim 47, wherein the second elastic member comprises a tension spring which is maximally tensioned at the neutral position.

55. The vibration isolation system as claimed in claim 54, wherein the tension spring is displaced in a second direction different from the first direction.

56. The vibration isolation system as claimed in claim 55, wherein the second direction is perpendicular to the first direction.

57. The vibration isolation system as claimed in claim 54, wherein the tension spring is displaced while pivoting on one end of the tension spring which is pivotably fixed.

58. The vibration isolation system as claimed in claim 47, wherein the link part comprises:
a first link which is fixed to the first object to move in the first direction;
a second link which is connected to the first link to convert a movement direction of the first link to a second direction; and
a third link which comprises one end connected to the second link and an other end connected to one end of the second elastic member,
wherein an other end of the second elastic member is fixed.

59. The vibration isolation system as claimed in claim 58, wherein the second direction is perpendicular to the first direction.

60. The vibration isolation system as claimed in claim 58, wherein the second elastic member comprises a tension spring which is displaced in the second direction, and wherein the tension spring is maximally tensed at the neutral position.

61. The vibration isolation system as claimed in claim 58, wherein the second elastic member comprises a compression spring which is displaced in the second direction, and wherein the compression spring is maximally compressed at the neutral position.

62. The vibration isolation system as claimed in claim 47, wherein the link part comprises a first link which is fixed to the first object to move in the first direction, and the second elastic member comprises a compression spring, and
wherein one end of the compression spring is connected to the first link, and the other end of the compression spring is pivotably fixed.

63. The vibration isolation system as claimed claim 62, wherein the compression spring is maximally compressed at the neutral position, and pivots and is displaced on the fixed other end thereof with maintaining a compression state according to the relative motions of the first and second objects.

64. The vibration isolation system as claimed in claim 47, wherein the link part comprises a first link which is fixed to the first object to move in the first direction and has a curved part, and wherein one end of the second elastic member contacts the curved part of the first link, and the other end of the second elastic member is fixed.

65. The vibration isolation system as claimed in claim 64, wherein the second elastic member contacts the curved part through a roller.

66. The vibration isolation system as claimed in claim 64, wherein the second elastic member comprises a compression spring which contacts the curved part while maintaining a compression state according to the relative motions of the first and second objects, and
wherein the curved part is formed so that the compression spring is maximally compressed at the neutral position.

67. The vibration isolation system as claimed in claim 64, wherein the second elastic member comprises a tension spring which contacts the curved part while maintaining a tension state according to the relative motions of the first and second objects, and
wherein the curved part is formed so that the tension spring is maximally tensed at the neutral position.

68. The vibration isolation system as claimed in claim 47, wherein the link part comprises:
a first link which is pivotably connected to the first object; and
a second link which is connected to the first link and comprises one end which is pivotably fixed to pivot according to the relative motions of the first and second objects,
wherein one end of the second elastic member is connected to the other end of the second link, and the other end of the second elastic member is pivotably fixed.

69. The vibration isolation system as claimed in claim 68, wherein the second elastic member comprises a tension spring, and wherein the one end of the second link is disposed in a position in which the tension spring is maximally tensed at the neutral position.

70. The vibration isolation system as claimed in claim 68, wherein the second elastic member comprises a compression spring, and wherein the one end of the second link is disposed in a position in which the compression spring is maximally compressed at the neutral position.

71. The vibration isolation system as claimed in claim 47, wherein a natural frequency of the vibration isolation system is less than or equal to 1 Hz.
